(19) United States
(12) Patent Application Publication
(10) Pub. No.: US 2017/0260981 A1
(43) Pub. Date: Sep. 14, 2017

(54) SEGMENTED ROTOR FORM FOR SUPERCHARGERS AND EXPANDERS

(71) Applicant: Eaton Corporation, Cleveland, OH (US)

(72) Inventor: Matthew G. Swartzlander, Battle Creek, MI (US)

(21) Appl. No.: 15/454,614

(22) Filed: Mar. 9, 2017

Related U.S. Application Data
(60) Provisional application No. 62/305,840, filed on Mar. 9, 2016.

(51) Int. Cl. F04C 18/12; F02B 33/38

(52) U.S. Cl. CPC F04C 18/126; F02B 33/38; F04C 2230/60; F04C 2240/20; F04C 2240/30; F04C 2240/60; F04C 2250/20

(57) ABSTRACT

A segmented rotor assembly built from individual rotor segments is presented. In one aspect, the segmented rotor assembly is defined by a plurality of lobes extending between a first lobe end and a second lobe end. Each lobe is constructed from a pair of identically shaped lobe segments mated to each other. Each lobe segment is provided with a helical twist extending between a first segment end and a second segment end. The constructed lobes can then be mated to each other to create a wholly formed rotor.

### RELATED APPLICATION

This application claims priority to U.S. Provisional Patent Application Ser. No. 62/305,840, filed on Mar. 9, 2016, the entirety of which is incorporated by reference herein.

### TECHNICAL FIELD

This application relates to assembled or modular rotary components, such as Roots-type rotors for superchargers and expanders.

### BACKGROUND

Various examples of Roots-type rotors for superchargers and expanders exist. In all cases, the rotors are provided with a helical twist which presents a challenge with respect to constructing a rotor having a relatively complex shape with low inertia. Consequently, Roots-type rotors are relatively expensive and time consuming to product.

### SUMMARY

A segmented rotor assembly is presented. The design of the segmented rotor breaks down the rotor shape and simplifies it into a single form to enable more flexibility in selection of a manufacturing process. The design also helps reduce material used and potential cost. In one aspect, the segmented rotor assembly is defined by a plurality of lobes extending between a first lobe end and a second lobe end. Each lobe is constructed from a pair of identically shaped lobe segments mated to each other. Each lobe segment is provided with a helical twist extending between a first segment end and a second segment end. The constructed lobes can then be mated to each other to create a wholly formed rotor. In one application, two rotors are installed into a supercharger assembly.

A method for forming a rotor assembly is also disclosed including the steps of providing a plurality of rotor segments, wherein each of the rotor segments has a helical twist and wherein at least two rotor segments are identically shaped, assembling the plurality of rotor segments to form a hollow rotor assembly with a plurality of helically twisted lobes, and securing the rotor segments to each other. The method can also include welding the rotor segments to each other. In one implementation all of the rotor segments that are provided are identical to each other.

Additional objects and advantages will be set forth in part in the description which follows, and in part will be obvious from the description, or may be learned by practice of the teachings presented herein. The objects and advantages will also be realized and attained by means of the elements and combinations particularly pointed out in the appended claims. It is to be understood that both the foregoing general description and the following detailed description are exemplary and explanatory only and are not restrictive of the claimed invention.

### BRIEF DESCRIPTION OF THE DRAWINGS

FIG. 1 is a schematic perspective view of a segmented rotor assembly, which is an example in accordance with aspects of the invention.

FIG. 2 is a schematic side view of the segmented rotor assembly shown in FIG. 1.

FIG. 3 is a schematic end view of the segmented rotor assembly shown in FIG. 1.

FIG. 4 is a schematic cross-sectional side view of the rotor assembly shown in FIG. 1, taken along the line A-A in FIG. 3.

FIG. 5 is a schematic exploded perspective view of the segmented rotor assembly shown in FIG. 1.

FIG. 6 is a schematic first side view of a rotor segment used to form the segmented rotor assembly of FIG. 1.

FIG. 7 is a schematic second side view of a rotor segment used to form the segmented rotor assembly of FIG. 1.

FIG. 8 is a schematic first end view of a rotor segment used to form the segmented rotor assembly of FIG. 1.

FIG. 9 is a schematic second end view of a rotor segment used to form the segmented rotor assembly of FIG. 1.

FIG. 9A is a schematic second end view of the rotor segment shown in FIG. 9, showing a variable wall thickness.

FIG. 10 is a schematic view of a vehicle having a compressor and a volumetric energy recovery device having features that are examples of aspects in accordance with the principles of the present disclosure and that can utilize rotors of the type disclosed at FIGS. 9 to 9A.

FIG. 11 is a perspective view of a supercharger assembly usable as the compressor shown at FIG. 10, within which the rotors of the type disclosed at FIGS. 9 to 9A can be utilized.

FIG. 12 is a cross-sectional side view of a device usable as either the compressor or energy recovery device shown at FIG. 10, within which the rotors of the type disclosed at FIGS. 9 to 9A can be utilized.

FIG. 13 is a schematic perspective view of a pair of the rotors shown at FIGS. 9 to 9A mounted to shafts in an interleaved orientation.

### DETAILED DESCRIPTION

Reference will now be made in detail to the examples which are illustrated in the accompanying drawings. Wherever possible, the same reference numbers will be used throughout the drawings to refer to the same or like parts. Directional references such as “left” and “right” are for ease of reference to the figures.

### Rotor Design

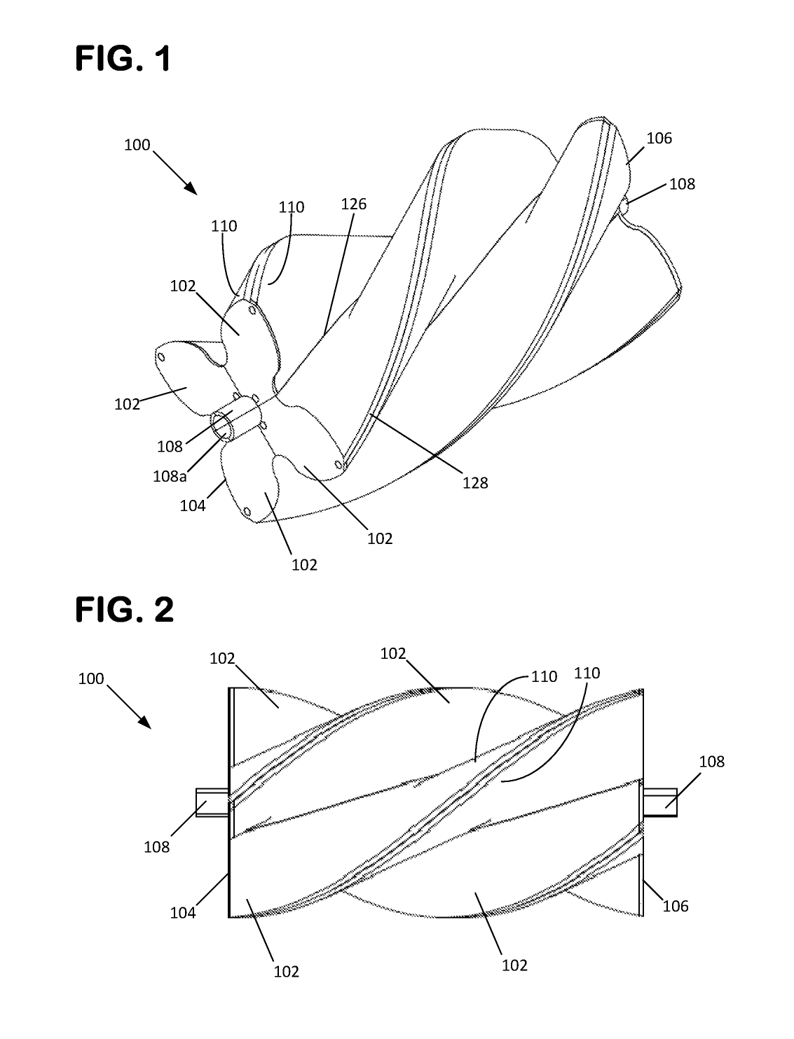

Referring to FIG. 1, a segmented rotor assembly 100 is shown that is constructed from multiples of a single repeating rotor segment 110. The segmented rotor assembly 100 includes a plurality of lobes 102 extending longitudinally from a first end 104 to a second end 106 of the rotor assembly 100. The lobes 102 are arranged about a hub portion 108 extending between the ends 104, 106. As shown, the hub portion 108, which is formed by the assembled rotor segments 110, defines a central aperture 108a that allows the segmented rotor assembly 100 to be mounted onto a solid shaft. The hub portion 108 can also serve as the shaft itself.

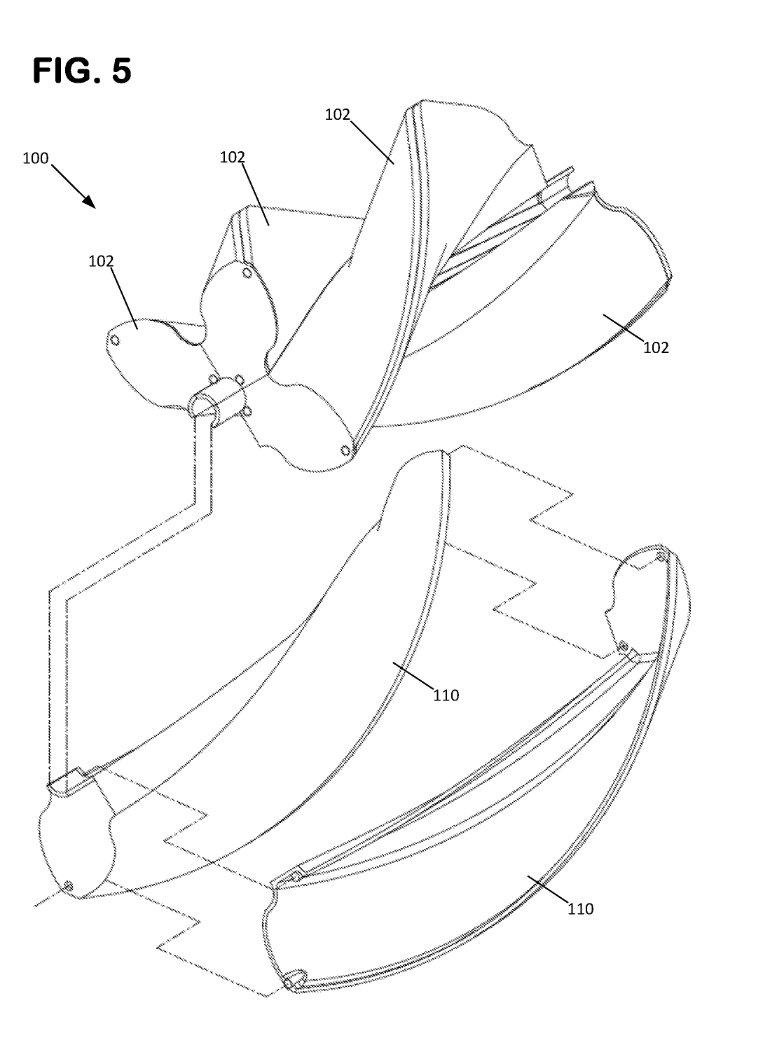

As most easily seen at FIG. 5, the rotor designs presented herein represent a pattern that is repeated in pairs to form the lobes 102. Where a three lobe rotor assembly is provided, three repeating lobe patterns exist. Where a four lobe rotor assembly is provided, as shown in the drawings, four repeating lobe patterns exist. Each of the lobes 102 is split into two rotor segments 110. Accordingly, a three lobe rotor assembly would include six repeating patterns while a four lobe rotor assembly would include eight repeating patterns. This approach allows a segmented rotor 100 to be assembled with one part, the rotor segment 110. By reversing the direction of the assembly split lobe, a single closed hollow lobe can be formed from two oppositely arranged and mated rotor segments 110. By splitting the lobe 102 in half, the geometry to be produced for the rotor segments 110 can be obtained by a simple stamping or molding process. Typical single piece rotors, due to the twist, have uncut or shrouded areas that prevent simple manufacturing tool design. In an alternative design, the rotor 100 could be formed by pairs of unique segments such that a four lobe segmented rotor would be still be formed by eight segments, but with four of one segment profile and four of a different, but complementary, segment profile.

The individual rotor segments 110 can be joined together, as described above, and secured together to form the assembled rotor 100. The segments 110 can be secured to each other by a variety of approaches, including welding (e.g. fusion welding such as arc welding, resistance welding, gas welding, electron beam welding, laser welding; and solid state welding such as diffusion welding, friction/stir welding, ultrasonic welding), brazing (e.g. furnace brazing, torch brazing, induction brazing, resistance brazing, dip brazing, infrared brazing), soldering, and bonding. After the rotor 100 has been fully formed, the outer surfaces of the rotor 100 may be subjected to a treatment process and subsequently provided with a coating, such as an abradable coating. One example of an abradable coating is an epoxy and graphite mixture that is electrostatically applied (i.e. powder coated) onto the exterior surfaces of the rotor.

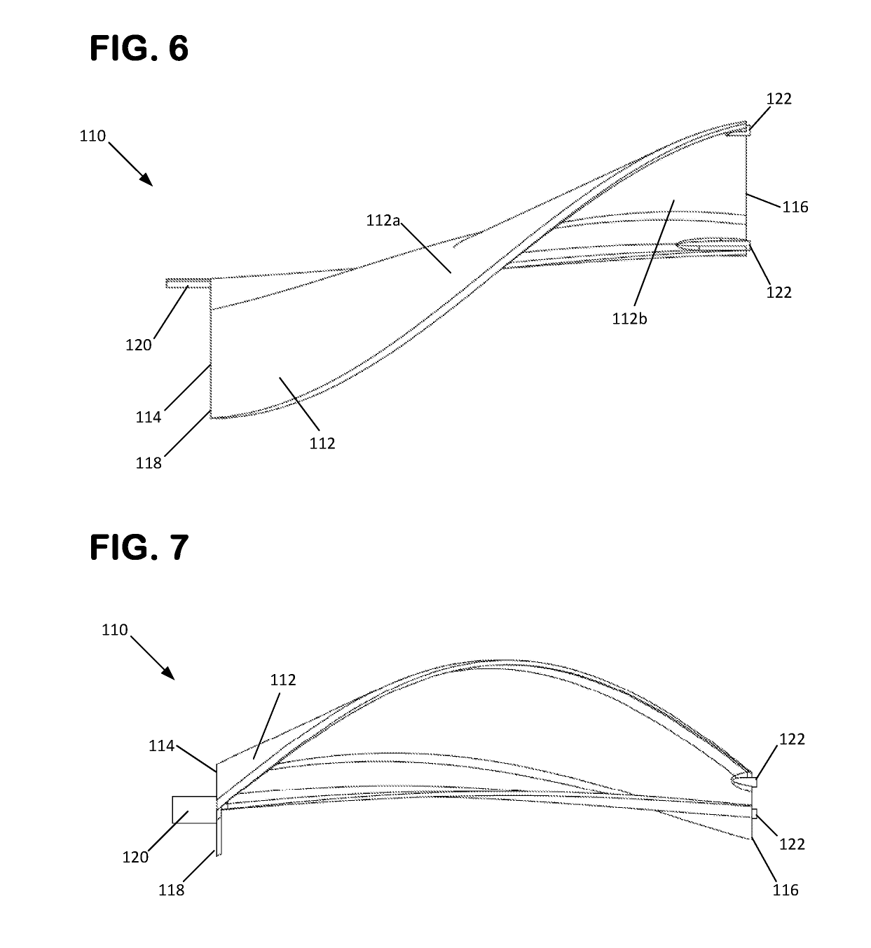

Referring to FIGS. 6-9, an individual rotor segment 110 that can be used to build the rotor assembly shown in FIGS. 1 to 5 is presented. As shown, each rotor segment 110 includes a sidewall 112 extending longitudinally from a first end 114 to a second end 116. The first and second ends 114, 116 of the rotor segment 110 correspond to the first and second ends 104, 106 of the rotor assembly 100. Accordingly, it should be appreciated that rotor assembly 100 is formed from a plurality of segments 110 that extend longitudinally across the entire length of the rotor assembly 100. The sidewall 112 has an outer surface 112a and an inner surface 112b. When the rotor assembly 100 is constructed, the outer surfaces 112a of the rotor segments 110 define the outer surface of the rotor assembly 100 and the inner surfaces 112b define the interior, hollow portion of the rotor assembly 100.

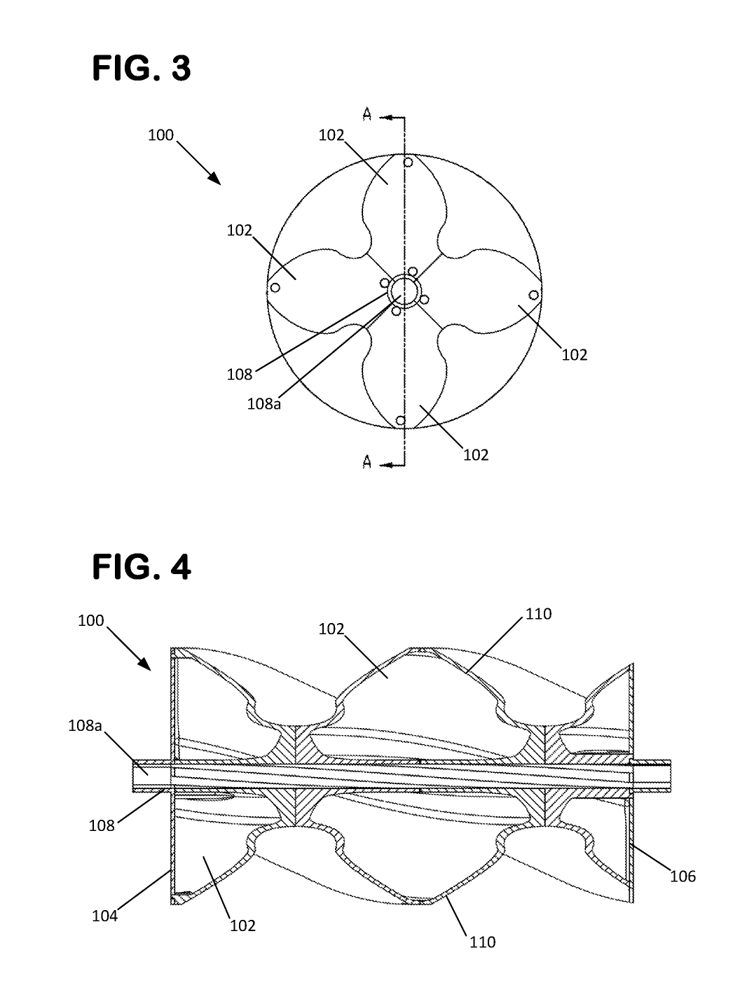

Each rotor segment 110 is also shown as including an end wall 118 extending orthogonally from the sidewall 112 at the first end 114 of the rotor segment 110. Thus, when two rotor segments 110 are oppositely oriented and mated together, the end walls 118 close off the ends of the lobe 102 formed by the mated rotor segments 110. In this manner, a hollow, enclosed lobe 102 can be formed. From the end wall 118, a hub segment 120 extends which assembles to form the hub portion 108 of the rotor assembly 100. Alternatively, the rotor segments 110 can be provided without the end wall 118 such that the ends of the assembled rotor 100 are initially open. The ends can be closed by a single plate having the same shape and area as the combined areas of the end walls 118, as most easily viewed at FIG. 3. The single plates can be sized to fit within the interior wall perimeter defined by the segments 110 (i.e. within and abutting interior surface 112b of sidewall 112) or can be sized to entirely cover the ends of the walls of the segments 110 (i.e. extending to outer wall surface 112a). In either approach, the single plates can be attached to the assembled segments 100 via welding or other processes.

At the second end 116 of the rotor segments, a pair of protrusions 122 extends axially from the sidewall 112. The protrusions 122 are configured to insert into corresponding apertures 124 of the end wall 118 of an oppositely oriented rotor segment 110 to aid in securing the rotor segments 110 together.

As shown, each rotor segment 110 extends radially outward from a root end 112c, proximate the hub segment 120, to a tip end 112d. When the rotor segments 110 are assembled, and as annotated at FIG. 1, the root ends 112c abut each other to form root portions 126 of the rotor 100 and the tip ends 112d abut each other to form tip portions 128 of the rotor 100. As can be most easily seen at FIG. 9, the thickness T112 of the sidewall 112 between the ends 112c, 112d is generally constant. Where the segments 110 are formed by stamping from a metal sheet, a generally constant thickness T112 results. Alternatively, the rotor segments 110 can be formed with a varying wall thickness T112 through alternative formation processes, for example, additive manufacturing, molding, casting, specialized stamping techniques, etc. In such instances, it can be advantageous to provide the sidewall 112 with a greater thickness t112c proximate the root end 112c relative to a thickness t112d proximate the tip end 112d, as schematically shown at FIG. 9A. By varying the thickness in this manner, the root portions 126 of the rotor 100 are provided with greater strength at a location where greater stresses are experienced by the rotor 100 while less material is provided at the tip portions 128 of the rotor 100. This configuration reduces deflection of the rotor 100 while rotating and thus allows for lower operating clearances between adjacent rotors 100 and between the rotors 100 and the housing within which the rotor is installed.

### Rotary Assembly Applications

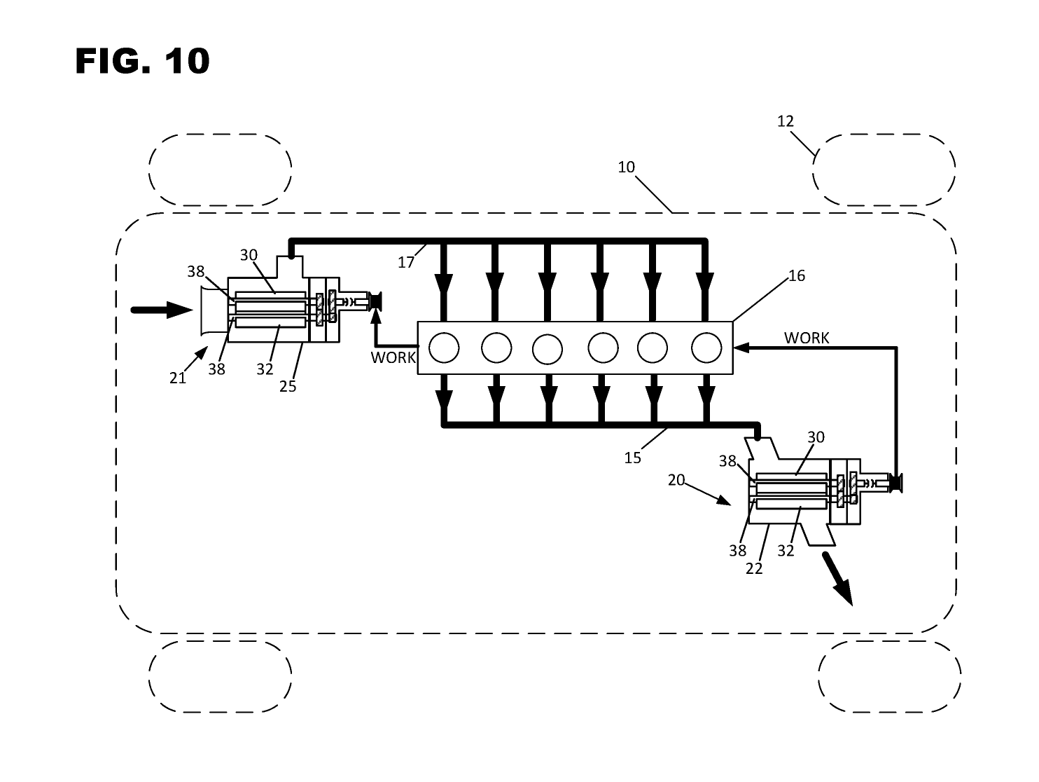

The above described segmented rotor assembly 100 may be used in a variety of applications involving rotary devices, as shown at FIGS. 10-13 which reference the rotor assembly 100 as rotors 30, 32. Two such applications can be for use in a fluid expander 20 and a compression device 21 (e.g. a supercharger), as shown in FIG. 10. In one example, the fluid expander 20 and compression device 21 are volumetric devices in which the fluid within the expander 20 and compression device 21 is transported across the rotors 30, 32 without a change in volume. FIG. 10 shows the expander 20 and supercharger 21 being provided in a vehicle 10 having wheels 12 for movement along an appropriate road surface. The vehicle 10 includes a power plant 16 that receives intake air 17 and generates waste heat in the form of a high-temperature exhaust gas in exhaust 15. In one example, the power plant 16 is a fuel cell. The rotor assembly 30 may also be used as a straight or helical gear (i.e. a rotary component) in a gear train, as a transmission gear, as a rotor in other types of expansion and compression devices, as an impeller in pumps, and as a rotor in mixing devices.

As shown in FIG. 10, the expander 20 can receive heat from the power plant exhaust 15 and can convert the heat into useful work which can be delivered back to the power plant 16 (electrically and/or mechanically) to increase the overall operating efficiency of the power plant. As configured, the expander 20 can include housing 22 within which a pair of rotor assemblies 30, 32 is disposed. Rotor assembly 32 is identical to rotor assembly 30. The expander 20 having rotor assemblies 30, 32 can be configured to receive heat from the power plant 16 directly or indirectly from the exhaust.

One example of a fluid expander 20 that directly receives exhaust gases from the power plant 16 is disclosed in Patent Cooperation Treaty (PCT) International Application Number PCT/US2013/078037 entitled EXHAUST GAS ENERGY RECOVERY SYSTEM. PCT/US2013/078037 is herein incorporated by reference in its entirety.

One example of a fluid expander 20 that indirectly receives heat from the power plant exhaust via an organic Rankine cycle is disclosed in Patent Cooperation Treaty (PCT) International Application Publication Number WO 2013/130774 entitled VOLUMETRIC ENERGY RECOVERY DEVICE AND SYSTEMS. WO 2013/130774 is incorporated herein by reference in its entirety.

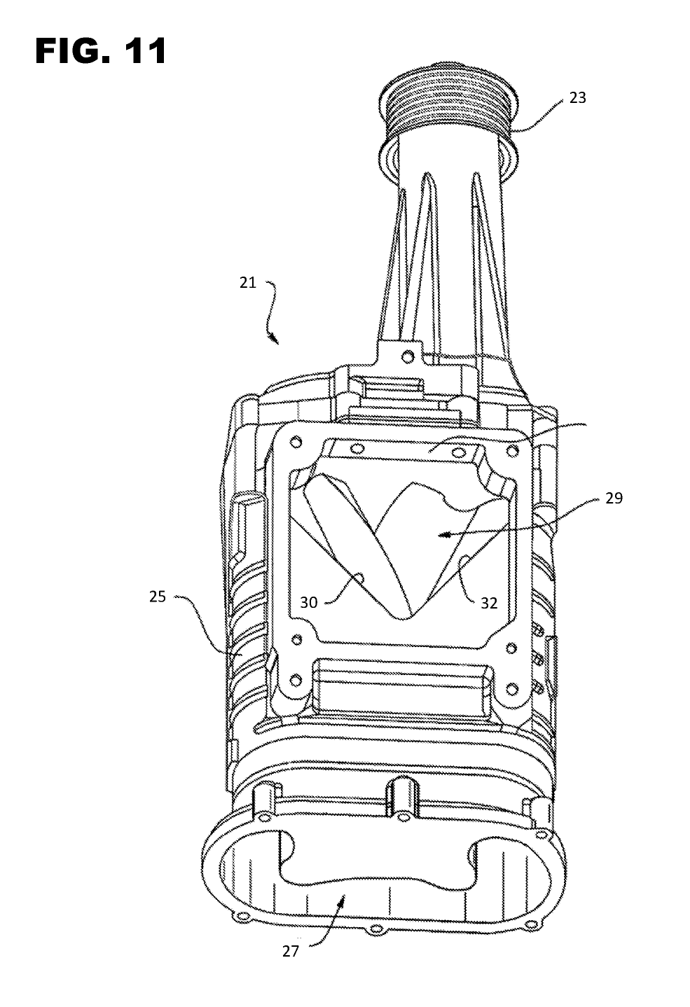

Referring to FIGS. 10 and 11, the compression device 21 can be shown provided with housing 25 having an air inlet 27 and an air outlet 29. A pair of rotor assemblies 30, 32 is disposed within the housing 25. As configured, the compression device can be driven by the power plant 16 via a pulley 23 connected to one of the shafts associated with the rotors 30, 32. As configured, the compression device 21 can increase the amount of intake air 17 delivered to the power plant 16. In one example, compression device 21 can be a Roots-type blower or supercharger of the type shown and described in U.S. Pat. No. 7,488,164 entitled OPTIMIZED HELIX ANGLE ROTORS FOR ROOTS-STYLE SUPERCHARGER, wherein the segmented rotor assemblies 30, 32 are configured to have a geometry matching those disclosed in U.S. Pat. No. 7,488,164. U.S. Pat. No. 7,488,164 is hereby incorporated by reference in its entirety. An additional example is provided at Patent Cooperation Treaty (PCT) International Publication Number WO 2013/148205, the entirety of which is incorporated herein by reference.

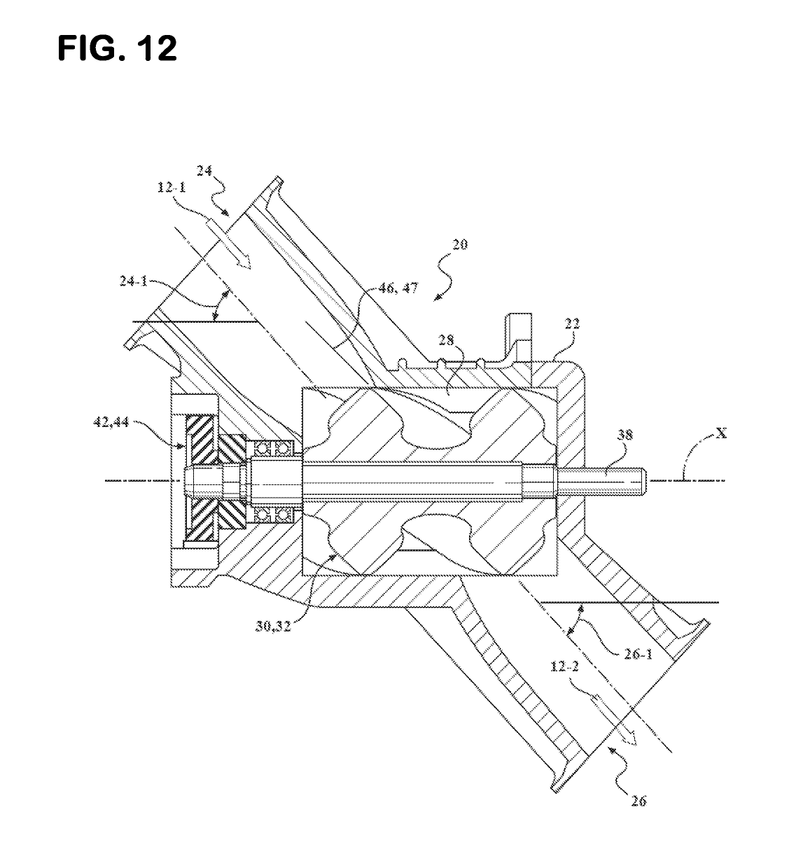

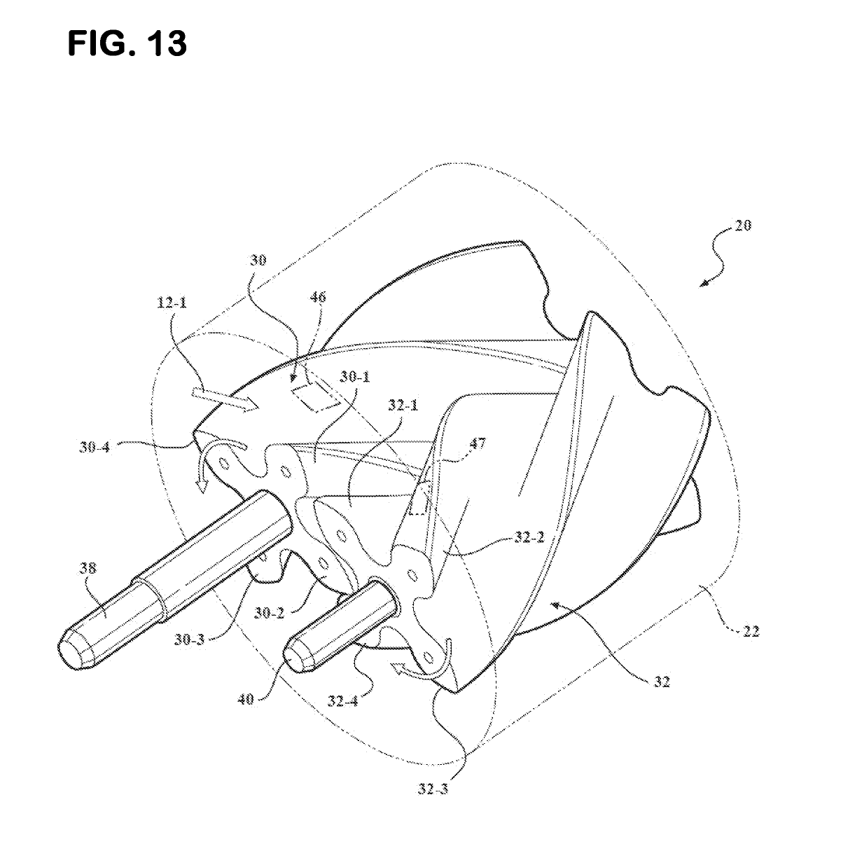

Referring to FIGS. 12 and 13, further aspects of the waste heat recovery device or expander 20 are shown. While some details of the expander 20 are discussed in this subsection and above, additional structural and operational aspects can be found in Patent Cooperation Treaty (PCT) International Publication Number WO 2014/144701 and in United States Patent Application Publication US 2014/0260245, the entireties of which are incorporated herein by reference.

In general, the volumetric energy recovery device or expander 20 relies upon the kinetic energy and static pressure of a working fluid to rotate an output shaft 38. The expander 20 may be an energy recovery device 20 wherein the working fluid 12-1 is the direct engine exhaust from the engine. In such instances, device 20 may be referred to as an expander or expander, as so presented in the following paragraphs.

With continued reference to FIGS. 12 and 13, it can be seen that the expander 20 has a housing 22 with a fluid inlet 24 and a fluid outlet 26 through which the working fluid 12-1 undergoes a pressure drop to transfer energy to the output shaft 38. The output shaft 38 is driven by synchronously connected first and second interleaved counter-rotating rotors 30, 32 which are disposed in a cavity 28 of the housing 22. The disclosed rotor 100 can be used for each of rotors 30, 32. Each of the rotors 30, 32 has lobes that are twisted or helically disposed along the length of the rotors 30, 32. Upon rotation of the rotors 30, 32, the lobes at least partially seal the working fluid 12-1 against an interior side of the housing at which point expansion of the working fluid 12-1 only occurs to the extent allowed by leakage which represents and inefficiency in the system. In contrast to some expanders that change the volume of the working fluid when the fluid is sealed, the volume defined between the lobes and the interior side of the housing 22 of device 20 is constant as the working fluid 12-1 traverses the length of the rotors 30, 32. Accordingly, the expander 20 may be referred to as a “volumetric device” as the sealed or partially sealed working fluid volume does not change.

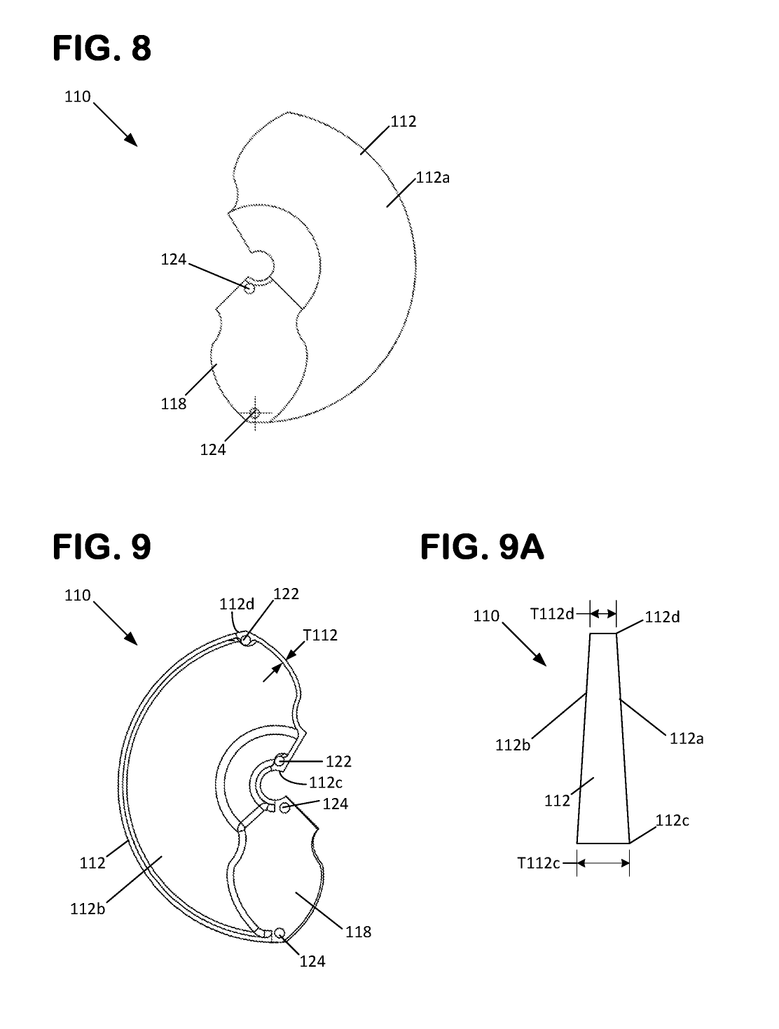

The expander 20 includes a housing 22. As shown in FIG. 8, the housing 22 includes an inlet port 24 configured to admit relatively high-pressure working fluid 12-1 from the heat exchanger 18 (shown in FIG. 4). The housing 22 also includes an outlet port 26.

As additionally shown in FIG. 13, each rotor 30, 32 (i.e. rotor 100) has four lobes, 30-1, 30-2, 30-3, and 30-4 in the case of the rotor 30, and 32-1, 32-2, 32-3, and 32-4 in the case of the rotor 32. Although four lobes are shown for each rotor 30 and 32, each of the two rotors may have any number of lobes that is equal to or greater than two, as long as the number of lobes is the same for both rotors. For example, the rotors can have three lobes. When one lobe of the rotor 30, such as the lobe 30-1 is leading with respect to the inlet port 24, a lobe of the rotor 32, such as the lobe 30-2, is trailing with respect to the inlet port 24, and, therefore with respect to a stream of the high-pressure working fluid 12-1.

As shown, the first and second rotors 30 and 32 are fixed to respective rotor shafts, the first rotor being fixed to an output shaft 38 and the second rotor being fixed to a shaft 40. Each of the rotor shafts 38, 40 is mounted for rotation on a set of bearings (not shown) about an axis X1, X2, respectively. It is noted that axes X1 and X2 are generally parallel to each other. The first and second rotors 30 and 32 are interleaved and continuously meshed for unitary rotation with each other. With renewed reference to FIG. 8, the expander 20 also includes meshed timing gears 42 and 44, wherein the timing gear 42 is fixed for rotation with the rotor 30, while the timing gear 44 is fixed for rotation with the rotor 32. The timing gears 42, 44 are configured to retain specified position of the rotors 30, 32 and prevent contact between the rotors during operation of the expander 20.

The output shaft 38 is rotated by the working fluid 12 as the working fluid undergoes expansion from the relatively high-pressure working fluid 12-1 to the relatively low-pressure working fluid 12-2. As may additionally be seen in both FIGS. 12 and 13, the output shaft 38 extends beyond the boundary of the housing 22. Accordingly, the output shaft 38 is configured to capture the work or power generated by the expander 20 during the expansion of the working fluid 12 that takes place in the rotor cavity 28 between the inlet port 24 and the outlet port 26 and transfer such work as output torque from the expander 20. Although the output shaft 38 is shown as being operatively connected to the first rotor 30, in the alternative the output shaft 38 may be operatively connected to the second rotor 32. In one aspect, the expander 20 can also be operated as a high volumetric efficiency positive displacement pump when driven by the motor/generator 70.

Other implementations will be apparent to those skilled in the art from consideration of the specification and practice of the examples and teachings presented herein. It is intended that the specification and examples be considered as exemplary only, with the true scope of the invention being indicated by the following claims.

What is claimed is:

1. A segmented rotor assembly:
a) a plurality of lobes extending between a first lobe end and a second lobe end, each lobe being defined by a pair of identically shaped lobe segments mated to each other, wherein each lobe segment is provided with a helical twist extending between a first segment end and a second segment end.

2. The segmented rotor assembly of claim 1, wherein the plurality of lobes includes three lobes.

3. The segmented rotor assembly of claim 1, wherein the plurality of lobes includes four lobes.

4. The segmented rotor assembly of claim 1, wherein the plurality of lobes are hollow.

5. The segmented rotor assembly of claim 1, wherein each lobe segment includes a sidewall extending between the first and second segment ends and an end wall extending from the sidewall at the first segment end, wherein when the rotor segments are mated, each of the plurality of lobes has closed ends.

6. The segmented rotor assembly of claim 5, wherein each end wall has at least one aperture for receiving at least one pin extending from the sidewall second end.

7. The segmented rotor assembly of claim 5, further comprising a hub portion extending from the end wall of each rotor segment, wherein when the plurality of lobes are mated to each other to form the segmented rotor assembly, the hub portions of each lobe form a hub defining a central aperture.

8. The segmented rotor assembly of claim 6, further comprising a shaft extending through the hub central apertures.

9. The segmented rotor assembly of claim 1, wherein the pair of lobe segments are welded together.

10. The segmented rotor assembly of claim 9, wherein the lobes are welded together.

11. The segmented rotor assembly of claim 1, wherein each of the lobe segments includes a sidewall extending longitudinally between the first and second segment ends and radially between a root end and a tip end, wherein the sidewall has a generally constant thickness between the root and tip ends.

12. The segmented rotor assembly of claim 1, wherein each of the lobe segments includes a sidewall extending longitudinally between the first and second segment ends and radially between a root end and a tip end, wherein the sidewall has a first thickness proximate the root end that is greater than a second thickness of the sidewall proximate the tip end.

13. A supercharger comprising:
a) a housing defining an internal cavity within which a pair of helically twisted, intermeshed segmented rotors is disposed;
b) wherein each rotor includes a plurality of hollow lobes extending between a first lobe end and a second lobe end, each lobe being defined by a pair of identically shaped lobe segments mated to each other, wherein each lobe segment is provided with a helical twist extending between a first segment end and a second segment end.

14. The supercharger of claim 13, wherein the plurality of lobes includes at least three lobes.

15. The supercharger of claim 13, wherein each lobe segment includes a sidewall extending between the first and second segment ends and an end wall extending from the sidewall at the first segment end, wherein when the rotor segments are mated, each of the plurality of lobes has closed ends.

16. The supercharger of claim 15, further comprising a hub portion extending from the end wall of each rotor segment, wherein when the plurality of lobes are mated to each other to form the segmented rotor assembly, the hub portions of each lobe form a hub defining a central aperture through which a shaft extends.

17. The supercharger of claim 13, wherein each of the lobe segments includes a sidewall extending longitudinally between the first and second segment ends and radially between a root end and a tip end, wherein the sidewall has a first thickness proximate the root end that is greater than a second thickness of the sidewall proximate the tip end.

18. A method for forming a rotor assembly comprising:
a) providing a plurality of rotor segments, wherein each of the rotor segments has a helical twist and wherein at least two rotor segments are identically shaped;
b) assembling the plurality of rotor segments to form a hollow rotor assembly with a plurality of helically twisted lobes; and
c) securing the rotor segments to each other.

19. The method of claim 18, wherein the step of securing the rotor segments to each other includes welding the rotor segments to each other.

20. The method of claim 18, wherein the step of providing a plurality of rotor segments includes providing only rotor segments that are identical to each other.
